(19) United States
(12) Patent Application Publication
(10) Pub. No.: US 2017/0270447 A1
(43) Pub. Date: Sep. 21, 2017

(54) METHOD AND SYSTEM FOR PROVIDING A DYNAMIC RIDE SHARING SERVICE

(71) Applicant: Telecom Italia S.p.A., Milano (IT)

(72) Inventors: Claudio BOREAN, Torino (IT); Roberta Giannantonio, Torino (IT); Simone Grandi, Torino (IT); Ennio Grasso, Torino (IT)

(73) Assignee: Telecom Italia S.p.A., Milano (IT)

(21) Appl. No.: 15/507,587

(22) PCT Filed: Sep. 2, 2014
(86) PCT No.: PCT/EP2014/068608

§ 371 Date: Feb. 28, 2017

(51) Int. Cl. G06Q 10/06; G06Q 50/30; H04W 4/08; G01C 21/34

(52) U.S. Cl. CPC G06Q 10/06313; G01C 21/3438; G06Q 50/30; H04W 4/08

(57) ABSTRACT

A method is proposed for arranging, in a ride sharing system (100) providing a ride sharing service, ride sharing proposals (RSP) to users of the ride sharing service. The method comprises the following steps: determining candidate users groups each one comprising users potentially matching to share a ride; defining (115) a cost function (C) comprising, for each candidate users group, at least one term indicative of an impact on the users of the ride sharing service in case the ride sharing takes place among candidate users group, and at least one weighting coefficient (cᵤ, cₑ, cₜ, cᵣ) each one associated with a respective one of said at least one term; minimizing (125) the cost function (C) thereby obtaining ride sharing proposals (RSP) for the users; sending the ride sharing proposals (RSP) to the respective users; receiving by the users acceptance feedbacks indicative of acceptance or rejection of the ride sharing proposals, and dynamically varying (120, 200) a value of said at least one weighting coefficient (cᵤ, cₑ, cₜ, cᵣ) according to an acceptance rate of the ride sharing proposals (RSP) by the users.

### BACKGROUND OF THE INVENTION

Field of the Invention

The present invention relates to ride sharing (such as carpooling and car sharing) services. More particularly, the present invention relates to a method and system for providing a dynamic ride sharing service.

Overview of the Related Art

In the last few decades, the number of vehicles is continuously increasing, and traffic congestion has become a common issue in most of urban environments. Due to traffic congestion, significant amounts of time are wasted for traveling, even over relatively short distances.

Furthermore, longer travel time typically corresponds to a higher utilization of fuel by the vehicle, which in turn corresponds to higher fuel expenses for the driver. Additionally, heavy traffic contributes to an increase in pollution, thereby creating a possible health hazard in some urban areas as well as an environmental problem.

Ride sharing (such as carpooling and car sharing) services are nowadays becoming very popular due to the rising fuel prices and users concerns about increasing traffic and pollution. Besides the conventional carpooling, which usually takes place among coworkers or neighbors during peak hours for commuting to and from the working place, dynamic or real-time ride sharing is becoming more common, wherein one-time rides on a very short notice are arranged.

US20120253654 discloses a carpool arranger and a method of operating the carpool arranger. The carpool arranger comprises at least one passenger internet device, at least one vehicle internet device and a central processing module. The method comprises: transmitting information from each passenger internet device and each vehicle internet device to a central processing module; planning an optimal route for a passenger internet device that transmits a carpool request; choosing appropriate vehicles; planning carpool routes for the chosen vehicles; and transmitting information from the central processing module to each passenger internet device and each vehicle internet device.

US20100280884 discloses an automated carpool matching. The method includes: collecting data from a first mobile communication device of a first user and from a second mobile communication device of a second user; determining a first travel pattern associated with the first user and a second travel pattern associated with the second user; determining a match between the first and second travel patterns; and generating a carpool proposal directed at the first and second users.

US20130159028 discloses a system for raising user satisfaction with an automated ride sharing system. According to an embodiment, the system may disqualify potential passengers that will force the driver to return to a previously departed area. According to another embodiment, the system may consolidate multiple stop locations to reduce the number and frequency of stops in a scheduled ride. According to another embodiment, the system may select a best possible ride from a plurality of calculated rides based on user satisfaction factors.

“Ridesharing: The state-of-the-art and future directions”, Elsevier, “Transportation Research Part B: Methodological”, 2013, pages: 28-46, discloses a thorough classification of the key aspects of existing ridesharing systems, and a framework that can help promote wide-spread adoption thereof.

### SUMMARY OF INVENTION

The Applicant has recognized that none of the cited prior art solutions is satisfactory.

Indeed, the Applicant has found that the prior art solutions are not able to provide a dynamic ride sharing service with improved quality of ride sharing proposals.

Moreover, no reference to how matching between users (passengers and drivers) is found is made explicit in US20120253654, no users reputation is taken into consideration in US20100280884, and only user preferences and geographic information are used in US20130159028.

In view of the above, the Applicant has tackled the problem of providing a dynamic ride sharing service, and, in order to achieve that, has devised a solution capable of providing ride sharing proposals based on an attempt of maximization acceptance rates by the users, so as to continuously improve the quality of the ride sharing proposals.

One or more aspects of the present invention are set out in the independent claims, with advantageous features of the same solution that are indicated in the dependent claims, whose wording is enclosed herein verbatim by reference (with any advantageous feature being provided with reference to a specific aspect of the solution according to an embodiment of the invention that applies mutatis mutandis to any other aspect).

More specifically, an aspect of the present invention relates to a method for arranging, in a ride sharing system providing a ride sharing service, ride sharing proposals to users of the ride sharing service. The method comprises the following steps:

determining candidate users groups each one comprising users potentially matching to share a ride;

defining a cost function comprising, for each candidate users group, at least one term indicative of an impact on the users of the ride sharing service in case the ride sharing takes place among candidate users group, and at least one weighting coefficient each one associated with a respective one of said at least one term;

minimizing the cost function thereby obtaining ride sharing proposals for the users;

sending the ride sharing proposals to the respective users;

receiving by the users acceptance feedbacks indicative of acceptance or rejection of the ride sharing proposals, and

dynamically varying a value of said at least one weighting coefficient according to an acceptance rate of the ride sharing proposals by the users.

According to an embodiment of the present invention, the users of the ride sharing service comprise drivers and passengers, and said at least one term of the cost function comprises, for each candidate users group, at least one between:

a term indicative of a number of passengers not assigned to any driver;

a term indicative of an estimated extra road for the driver;

a term indicative of waiting times of the passengers, and

a term indicative of reputation scores of the driver and of the passenger.

According to an embodiment of the present invention, said number of passengers not assigned to any driver are discriminated according to at least one threshold comprising at least one between an extra road threshold indicative of a maximum allowed extra road that satisfying the passengers would imply for the drivers, and a waiting time threshold indicative of a maximum allowed waiting time that satisfying the passengers would imply for drivers and/or passengers, said dynamically varying a value of said at least one weighting coefficient according to an acceptance rate of the ride sharing proposals by the users further comprising dynamically varying also a value of said at least one threshold according to the acceptance rate of the ride sharing proposals by the users.

According to an embodiment of the present invention, said dynamically varying comprises performing a learning procedure based on history values of said at least one weighting coefficient and on the acceptance rate of the ride sharing proposals resulting from the minimization of the respective cost functions.

According to an embodiment of the present invention, said performing a learning procedure comprises, at each iteration:

receiving the acceptance feedbacks of the ride sharing proposals resulting from the minimization of the cost function based on the values of at least one weighting coefficient determined at a previous iteration;

based on the acceptance feedbacks, training a Bayesian Beta prior with a basis function kernel, and building a surrogate model of the acceptance rate according to mean and variance of the Bayesian Beta prior, and

finding a global maximum of the surrogate model, said global maximum corresponding to values of the at least one weighting coefficient that maximize the acceptance rate at the current iteration.

According to an embodiment of the present invention,

said performing a learning procedure is also based on history values of said at least one threshold, and

at each iteration, said receiving comprises receiving the acceptance feedbacks of the ride sharing proposals resulting from the minimization of the cost function further based on the values of the at least one threshold determined at the previous iteration, said global maximum further corresponding to values of the at least one threshold that maximize the acceptance rate at the current iteration.

According to an embodiment of the present invention, said building a surrogate model comprises building a surrogate model by means of an “Expected Improvement” criterion.

According to an embodiment of the present invention, said finding a global maximum of the surrogate model is based on “Quantum Particle Optimization with Lévy flights” approach.

According to an embodiment of the present invention, said receiving the acceptance feedbacks comprises receiving a predefined number of acceptance feedbacks about the ride sharing proposals before starting said training a Bayesian Beta prior with basis function kernel, said building a surrogate model and said finding a global maximum of the surrogate model.

According to an embodiment of the present invention, the method further comprises keeping the learning procedure always running while the method is performed.

According to an embodiment of the present invention, said reputation scores comprise, for each candidate user group, a first reputation score of the driver according to the passenger, and a second reputation score of the passenger according to the driver. The method further comprises:

updating the first reputation score at the reception of each first reputation feedback about the driver from the passenger, and updating the second reputation score at the reception of each second reputation feedback about the passenger from the driver.

According to an embodiment of the present invention, said updating the first reputation score, respectively the second reputation score, is based on a parameter depending on a number of received first reputation feedbacks, respectively second reputation feedbacks, and on a time passed since the last first reputation feedbacks, respectively the last second reputation feedback, received.

According to an embodiment of the present invention, the method further comprises

determining a first further reputation score of the driver according to the ride sharing system and a second further reputation score of the passenger according to the ride sharing system, and

calculating first, respectively second, global reputation scores according to the first and first further reputation scores, respectively according to the second and second further reputation scores, the term of the cost function indicative of the number of passengers not assigned to any driver and the term of the cost function indicative of waiting times of the passengers depending on said second global reputation score.

According to an embodiment of the present invention, said minimizing the cost function is performed by means of a metaheuristic approach based on “Quantum Particle Optimization with Lévy flights”, or by means of an exact approach.

Another aspect of the present invention relates to a computer program product for implementing said method.

A further aspect of the present invention relates to a ride sharing system providing a ride sharing service. The ride sharing system comprises:

a first module for providing, to users of the ride sharing service, ride sharing proposals and for receiving by the users acceptance feedbacks indicative of acceptance or rejection of the ride sharing proposals,

a second module for defining a cost function comprising, for each candidate users group each one comprising users potentially matching to share a ride, at least one term indicative of an impact on the users of the ride sharing service in case the ride sharing takes place among the candidate users group, and at least one weighting coefficient each one associated with a respective one of said at least one term;

a third module for dynamically varying a value of said at least one weighting coefficient according to an acceptance rate of the ride sharing proposals by the users, and

a fourth module for minimizing the cost function thereby obtaining the ride sharing proposals for the users.

The present invention allows dynamically managing users matching (for sharing occasional rides) with a very short notice while providing a proposal good enough to encourage the users to keep using the service for next occasional rides. Moreover, the present invention is flexible enough to deal with a number of (drivers and passengers) requests that is changing very fast over time and take care of users feedbacks (about the proposals) to tune itself by autonomously learning through experience and improving the quality of the proposals.

Moreover, the present invention, as requiring low processing times, is adapted to be used in scenarios having a large number of users.

The Applicant has also found that although conceived for matching drivers and passengers in a ride sharing service, the present invention lends itself to be applied to other scenarios wherein matching between two or more services/items has to be dynamically (or real-time) provided. By way of example only, passengers might be goods/items (such as parcels, garbage), instead of persons, to be transported, whereas drivers could be truck drivers, and the present invention may be aimed at arranging good/items harvesting on trucks by identifying optimum road paths plans to be followed by them (e.g., so as to avoid time and cost wasting due, for example, to empty trucks travelling).

### BRIEF DESCRIPTION OF THE ANNEXED DRAWINGS

These and other features and advantages of the present invention will be made apparent by the following description of some exemplary and non limitative embodiments thereof. For its better intelligibility, the following description should be read making reference to the attached drawings, wherein:

FIG. 1 schematically shows a ride sharing system according to an embodiment of the present invention, and

FIG. 2 schematically shows a procedure, carried out by the ride sharing system, for optimizing an acceptance rate of ride sharing proposals according to an embodiment of the present invention.

### DETAILED DESCRIPTION OF PREFERRED EMBODIMENTS OF THE INVENTION

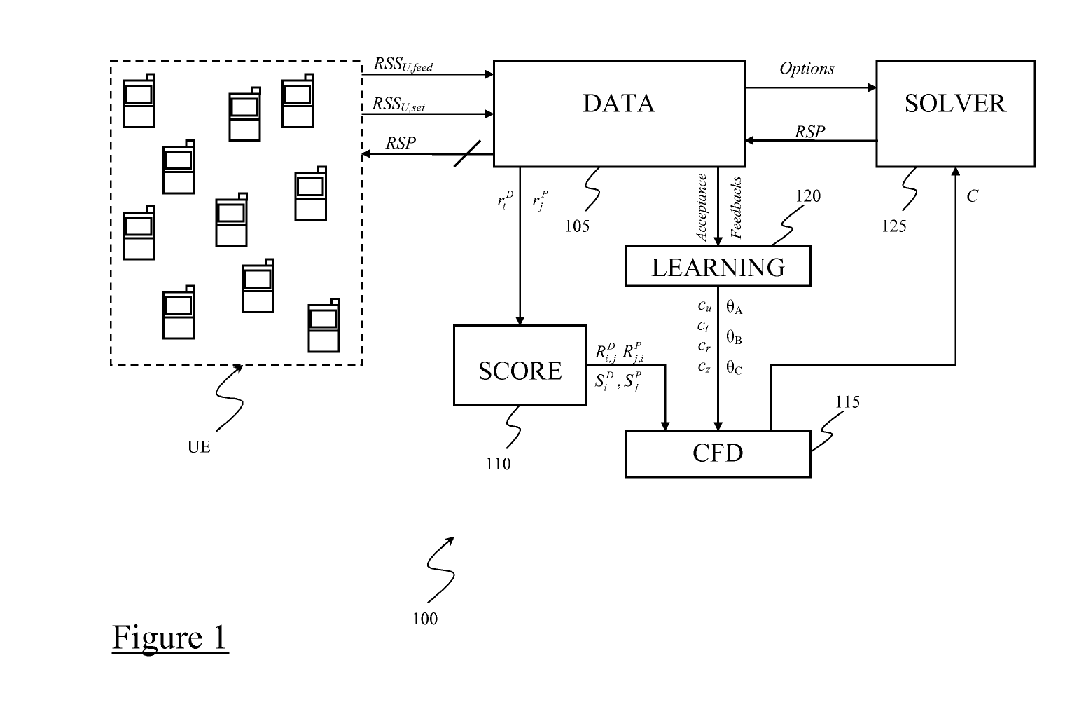

With reference to the drawings, FIG. 1 shows, in terms of functional modules, a “Ride Sharing System” (hereinafter, RSS system for the sake of conciseness) 100—providing a ride sharing service (or RSS service)—according to an embodiment of the present invention. As a preliminary consideration, it is pointed out that the use of the term “module” is herein intended to emphasize functional (rather than implementation) aspects thereof. Indeed, without losing of generality, each module may be implemented by software (in which case, the resulting algorithm would be performed by proper code means included in a computer program, when the program is run on a computer), hardware, and/or a combination thereof.

The RSS system 100 is adapted to dynamically interact (i.e., to exchange real-time information) with users of the RSS service (hereinafter, RSS users for the sake of conciseness), e.g. by means of a dedicated application (or RSS application) on their user equipment UE, in order to arrange one-time shared rides by smartly matching passengers demand and drivers offer.

The user equipment UE, not limiting for the present invention, may be any electronic devices, such as tablets or smartphones, provided with “Global Positioning System” (GPS) capabilities for determining drivers and passengers routes and positions, and internet connection functionalities for allowing said real-time information exchanging between the user equipment UE and the RSS system 100.

As discussed below, said real-time information comprises, but is not limited to, ride sharing proposals RSP (i.e., proposals of groups of two or more RSS users adapted to share rides) from the RSS system 100 (e.g., from a data module 105 thereof) to the RSS users (i.e., the associated user equipment UE), as well as RSS users feedbacks RSS_{U,feed} (e.g., implicit feedbacks resulting from acceptance or rejection of ride sharing proposals RSP by the RSS users, and/or explicit feedbacks about RSS users behaviors after the ride has taken place), and RSS users settings RSS_{U,set} from the RSS users (i.e., the associated user equipments UE) to the RSS system 100 (e.g., the data module 105 thereof). As better discussed in the following, the RSS users feedbacks RSS_{U,feed} and settings RSS_{U,set} are used by the RSS system 100 to determine more and more likely-accepted ride sharing proposals RSP.

The RSS users settings RSS_{U,set}, preferably selected by each RSS user by means of the RSS application and transmitted to the data module 105 by means of the user equipment UE wherein the RSS application is installed, may comprise:
registration and RSS users profiling. Advantageously, although not necessarily, the RSS application is provided with social networks integration capabilities, thereby allowing login-by-social network as a login option as well as establishing trust and accountability between the RSS users;
definition/declaration of the role the RSS user is intended to play in the RSS system 100. In the exemplary considered scenario, each RSS user may declare himself/herself (i.e., request) as a passenger or may declare (i.e., offer) himself/herself as a driver. The number of RSS users declared as passengers (hereinafter, passengers for the sake of conciseness) and the number of RSS users declared as drivers (hereinafter, drivers for the sake of conciseness) determine the passengers demand and drivers offer. In the following, a number i=1, 2, 3, . . . , I of drivers and a number j=1, 2, 3, . . . , J of passengers will be considered;
availability (e.g., a destination address) of the i-th driver, either explicitly (e.g., by allowing each i-th driver to explicitly signal a destination address) or implicitly (e.g., by leaving the RSS system 100 to infer the destination address, for example according to history information, of the i-th driver);
request of the j-th passenger, e.g. including a departure address (for example, a GPS-based current position of the j-th passenger) and a destination address, either explicitly (e.g., by allowing the j-th passenger to explicitly signal a destination address) or implicitly (e.g., by leaving the RSS system 100 to infer the destination address, for example according to history information, of the j-th passenger);
RSS user options, such as a maximum time the RSS user (either driver or passenger) are willing to wait, personal preferences about other RSS users (e.g., smokers/non-smokers, male/female, pet allowed/not allowed), and number of presently available seats of the driver vehicle; and
acceptance or rejection of a ride sharing proposal RSP.

According to the exemplary disclosed embodiment, RSS users feedbacks RSS_{U,feed} are based on acceptance (hereinafter, referred to as acceptance feedbacks) and on reputation (hereinafter, reputation feedbacks).

Acceptance feedbacks comprise the (implicit) feedbacks given by the RSS users at the time when they accept or reject a ride sharing proposal RSP. As better discussed in the following, the acceptance feedbacks are taken into account by the RSS system 100 to improve its performance through autonomous learning capabilities thereof, such that, when a ride sharing proposal RSP is either accepted or rejected, dynamical adjusting of a cost function takes place for increasing fulfilling RSS users expectations.

Reputation feedbacks instead comprise feedbacks (e.g., number ratings) about RSS users behaviors, once the RSS users accept a ride sharing proposal RSP and share the ride, and, as better discussed herebelow, may be computed by the RSS system 100 (for example, by the data logic module 105) based on adherence to the ride sharing proposals RSP, communicated by the RSS users (after the ride has taken place)—e.g., according to fulfillment/non-fulfillment of the RSS user options and/or to company pleasure, or a combination thereof.

Considering the exemplary scenario wherein the i-th driver and the j-th passenger accept a ride sharing proposal RSP and share the ride, the RSS system 100 (e.g., the data module 105) is preferably configured to ask for (e.g., by means of a questionnaire notified by the RSS application), and to receive driver and passenger reputation feedbacks, namely:
F_{i,j}^{D}, i.e. the reputation feedback about the i-th driver from the j-th passenger;
F_{j,i}^{P}, i.e. the reputation feedback about the j-th passenger from the i-th driver;

Preferably, as herein assumed, the RSS system 100 (e.g., the data module 105) is also configured to compute, for its own account, a reputation feedback for each RSS user, i.e. an indication of RSS user reliability for the RSS system 100, or, otherwise stated, an indication of how much accurately (e.g., how often) a RSS user follows the ride sharing proposals RSP from the RSS system 100, namely:
fᵢ^{D}, i.e. the reputation feedback about the i-th driver by the RSS system 100;
fⱼ^{P}, i.e. the reputation feedback about the j-th passenger by the RSS system 100;

Preferably, the reputation feedbacks F_{i,j}^{D}, F_{j,i}^{P}, fᵢ^{D}, fⱼ^{P} give rise to corresponding reputation scores/indexes for each RSS user (and, hence, for each determined candidate user group) namely:
R_{i,j}^{D}, i.e. the reputation score of the i-th driver according to the j-th passenger;
R_{j,i}^{P}, i.e. the reputation score of the j-th passenger according to the i-th driver;
rᵢ^{D}, i.e. the reputation score of the i-th driver according to the RSS system 100;
rⱼ^{P}, i.e. the reputation score of the j-th passenger according to the RSS system 100.

Whenever a new reputation feedback F_{i,j}^{D}, F_{j,i}^{P}, fᵢ^{D}, fⱼ^{P} is received/computed at the data module 105, the corresponding reputation score R_{i,j}^{D}, R_{j,i}^{P}, rᵢ^{D}, rⱼ^{P} is updated (e.g., still at the data module 105) as follows:

R_{i,j}^{D}→αF_{i,j}^{D}+(1−α)R_{i,j}^{D}

R_{j,i}^{P}→αF_{j,i}^{P}+(1−α)R_{j,i}^{P}

rᵢ^{D}→αfᵢ^{D}+(1−α)rᵢ^{D}

rⱼ^{P}→αfⱼ^{P}+(1−α)rⱼ^{P}

wherein α=α (n,t) is a parameter that is a function of/depends on the number n of reputation feedbacks already received by the RSS user and on the time t passed since the last reputation feedback received—i.e., the reputation score R_{i,j}^{D}, respectively the reputation score R_{j,i}^{P}, is updated according to the number n of last received reputation feedbacks F_{i,j}^{D}, respectively reputation feedbacks F_{j,i}^{P}, and on time t passed since the last reputation feedback F_{i,j}^{D}, respectively the last reputation feedback R_{j,i}^{P}, received. Preferably, dependency of the parameter α by n and t is set so that the influence of old reputation scores depends on how old and consolidated they are in order to achieve that, according to an embodiment of the present invention, the parameter α decreases as n increases, and increases as t increases.

From the reputation scores R_{i,j}^{D},R_{j,i}^{P} according to the RSS users (i.e., the reputation scores of the i-th driver according to the j-th passenger and of the j-th passenger according to the i-th driver, respectively, in the considered scenario) and from the reputation scores rᵢ^{D},rⱼ^{P} according to the RSS system 100, global (i.e. overall or absolute) reputation scores for each RSS user are calculated. In the example herein considered of the i-th driver and the j-th passenger, the global reputation scores, denoted by Sᵢ^{D},Sⱼ^{P} respectively, are calculated (e.g., still at the data module 105) as follows:

Sᵢ^{D}=βrᵢ^{D}+(1−β)ΣⱼR_{i,j}^{D} for the i-th passenger;

Sⱼ^{P}=βrⱼ^{P}+(1−β)ΣᵢR_{j,i}^{P} for the j-th passenger;

wherein β is a constant between 0 and 1.

As visible in the figures, the updated reputation scores R_{i,j}^{D}, R_{j,i}^{P}, rᵢ^{D}, rⱼ^{P} and the updated global reputation scores Sᵢ^{D}, Sⱼ^{P} are stored in a score module 110 of the RSS system 100 (and, as discussed below, taken therefrom for defining a cost function whose minimization leads to ride sharing proposals RSP).

As should be readily understood, integration of the RSS application with other networks, such as social networks, may allow computing more accurate global reputation scores (e.g., by exploiting RSS users relationships through such social networks). By way of non limiting example only, the ride sharing proposal RSP may be based on the existence of a social relation between the i-th driver and the j-th passenger. Additionally or alternatively, ratings given into the RSS system 100 may be shared with social links such that, if a direct link has not yet established into the RSS service, ratings given by social links are taken as own (for example, if the i-th driver and the j-th passenger have a social relationship and the i-th driver rates a different passenger for a shared ride, then the latter and the j-th passenger may “share” the reputation scores, or the global reputation scores).

Back to the figure, the RSS system 100 also comprises a “Cost Function Definition” (CFD) module 115, which is configured to determine (and continuously update) a cost function C (whose solving, as will be better understood from the following description, allows determining appropriate ride sharing proposals RSP), according to the reputation scores R_{i,j}^{D},R_{j,i}^{P} and the global reputation scores Sᵢ^{D}, Sⱼ^{P} (from the score module 110), and to the acceptance feedbacks.

Broadly speaking, the cost function C comprises, for each candidate group of users potentially adapted (i.e., potentially matching) to share a ride (as comprising the i-th driver and one or more j-th passengers), or candidate users group, one or more terms indicative of an impact/cost on the RSS users in the case the ride sharing takes place among the users of the candidate users group. As better discussed in the following, the ride sharing proposals RSP comprise users groups that minimize the cost function C (and, preferably, meet the RSS users options included in the RSS users settings RSS_{U,set}).

According to an embodiment of the present invention, the cost function C is defined as follows:

$$C = {c}_{u} {\sum }_{j ∈ P} {S}_{j}^{P} {1}_{A ⋂ B ⋂ C} + {c}_{e} {\sum }_{i ∈ D} ( {l}_{i , new} - {l}_{i , odd} ) + {c}_{t} {\sum }_{j ∈ P} {S}_{j}^{P} {w}_{j} - {c}_{r} {\sum }_{{i ∈ D}_{j ∈ P}} {I}_{( i , j )} ( {R}_{i , j}^{D} + {R}_{j , l}^{P} )$$

$$A = \{ j \text{:} {l}_{d ( j ) , new} - {l}_{d ( j ) , old} > {θ}_{A} \}$$

$$B = \{ j \text{:} {l}_{d ( j ) , new} - {l}_{d ( j ) , old} / {l}_{d ( j ) , old} > {θ}_{B} \}$$

$$C = \{ j \text{:} w ( j ) > {θ}_{C} \}$$

wherein:
the term

$${c}_{u} {\sum }_{j ∈ P} {S}_{j}^{P} {1}_{A ⋂ B ⋂ C}$$

takes into account the number of passengers left without a passage (i.e., a shared ride) and adds a penalty proportional to their global reputation scores Sⱼ^{P}. The j-th passenger may be left without a ride either because the number of requests is higher than the number of available drivers, or the extra road to be driven by the assigned driver is either too long or time-wasting. According to an embodiment of the present invention, discrimination of the j-th passengers to be left without a ride takes place according to at least one threshold, preferably comprising at least one between an extra road threshold indicative of a maximum allowed extra road that satisfying the j-th passengers would imply for any i-th driver (the extra road threshold comprising, in the example at issue, both an absolute extra road threshold θ_{A}, in km, and a relative extra road threshold, θ_{B}, in percentage of elongation), and a waiting time threshold θ_{C} indicative of a maximum allowed waiting time that satisfying the j-th passengers would imply for any available drivers and/or for the j-th passengers themselves. In other words, the thresholds θ_{A}, θ_{B}, θ_{C} are used for discriminating the j-th passengers not considered in the forthcoming ride sharing proposals RSP—and, hence, such thresholds θ_{A}, θ_{B}, θ_{C} will be referred to also as discriminating thresholds θ_{A}, θ_{B}, θ_{C} hereinafter;
the term

$${\sum }_{i ∈ D} ( {l}_{i , new} - {l}_{i , old} )$$

relates to minimization of the total road driven. l_{i,new} indicates the estimated length of the road to be driven by the i-th driver taking into account the assigned/matched j-th passenger, and l_{i,old} is the length of the road without the assignment/matching of the j-th passenger;
the term

$${\sum }_{j ∈ P} {S}_{j}^{P} {w}_{j}$$

relates to minimization of waiting times for the passengers. wⱼ represents the expected waiting time of the j-th passengers before their assigned i-th drivers pick them up;
the term

$${\sum }_{{i ∈ D}_{j ∈ P}} {I}_{( i , j )} ( {R}_{i , j}^{D} + {R}_{j , l}^{P} )$$

relates to, and promotes, combinations of drivers and passengers with good reciprocal reputations. I_{i,j} is 1 if the pair i-th driver/j-th passenger is in the proposed matching, 0 otherwise; and
cᵤ, cₑ, cₜ and cᵣ are weighting coefficients. As discussed herebelow, the values of the weighting coefficient cᵤ, cₑ, cₜ, cᵣ are dynamically updated to improve the quality of solutions proposed to drivers and passengers—in particular, the higher the value of a weighting coefficient cᵤ, cₑ, cₜ, cᵣ, the higher the weight assigned to that particular feature of the cost function C. Additionally (as considered in the present disclosure by way of example only) or alternatively, also the discriminating thresholds θ_{A}, θ_{B}, θ_{C} are dynamically updated (preferably, contextually with the weighting coefficient cᵤ, cₑ, cₜ, cᵣ), so as to make discrimination of the passengers that can be left without a ride more efficient and try to take charge of the largest number of passengers requests as possible.

As should be readily understood, embodiments providing only some of the above terms of the cost function C are not excluded, as well as cost functions C comprising, additionally or alternatively to at least part the above terms, other terms (not herein discussed) may be conceived without departing from the scope of the present invention.

According to an embodiment of the present invention, the values of the weighting coefficients cᵤ, cₑ, cₜ and cᵣ and the discriminating thresholds θ_{A}, θ_{B}, θ_{C} are dynamically updated according to an acceptance rate of the ride sharing proposals RSP by the RSS users (by acceptance rate meaning the number of times ride sharing proposals RSP acceptances happen, with respect to ride sharing proposals RSP rejections, over a predefined period of time or over a predefined number of received acceptance feedbacks) and, preferably, according to a reinforcement learning approach/procedure (learning module 120)—i.e. a learning approach whose learning capabilities are based on the history values of the weighting coefficients cᵤ, cₑ, cₜ, cᵣ and the discriminating thresholds θ_{A}, θ_{B}, θ_{C}, and on the corresponding acceptance feedbacks of the ride sharing proposals RSP.

Thanks to reinforcement learning, the values of the weighting coefficients cᵤ, cₑ, cₜ, cᵣ and of the discriminating thresholds θ_{A}, θ_{B}, θ_{C} are updated so that the ride sharing proposals RSP resulting from solving of the corresponding cost function C get closer and closer to the ideal acceptance rate of 100% or, otherwise stated, the values of the weighting coefficients cᵤ, cₑ, cₜ, cᵣ and of the discriminating thresholds θ_{A}, θ_{B}, θ_{C} are continuously updated so that the mismatch between the best ride sharing proposals RSP according to the RSS system 100 and the best ride sharing proposals RSP according to the RSS users is more and more reduced. In other words, as better discussed herebelow, the learning module 120 aims at determining values of the weighting coefficients cᵤ, cₑ, cₜ, cᵣ and of the discriminating thresholds θ_{A}, θ_{B}, θ_{C} that make the ride sharing proposals RSP the best ones, thereby achieving high (theoretically maximum) acceptance rate by the RSS users.

According to an embodiment of the present invention, reinforcement learning is based on Bayesian approach (Michael E. Tipping, “Bayesian Inference: An Introduction to Principles and Practice in Machine Learning”), i.e. on optimization of a surrogate model of a real function—in the RSS system 100 herein considered, such a real function, hereinafter referred to also as objective function, is represented by the acceptance rate of the RSS users. Since the objective function is costly to evaluate directly on the RSS users, the Bayesian approach is to treat it as a random function and place a prior over it. The prior captures beliefs about the behavior of the objective function. After gathering the objective function evaluations, which are treated as data, the prior is updated to form the posterior distribution over the objective function. The posterior distribution, in turn, is used as a surrogate model of the real objective function so that optimization can be performed on this surrogate model rather than directly interacting with RSS users.

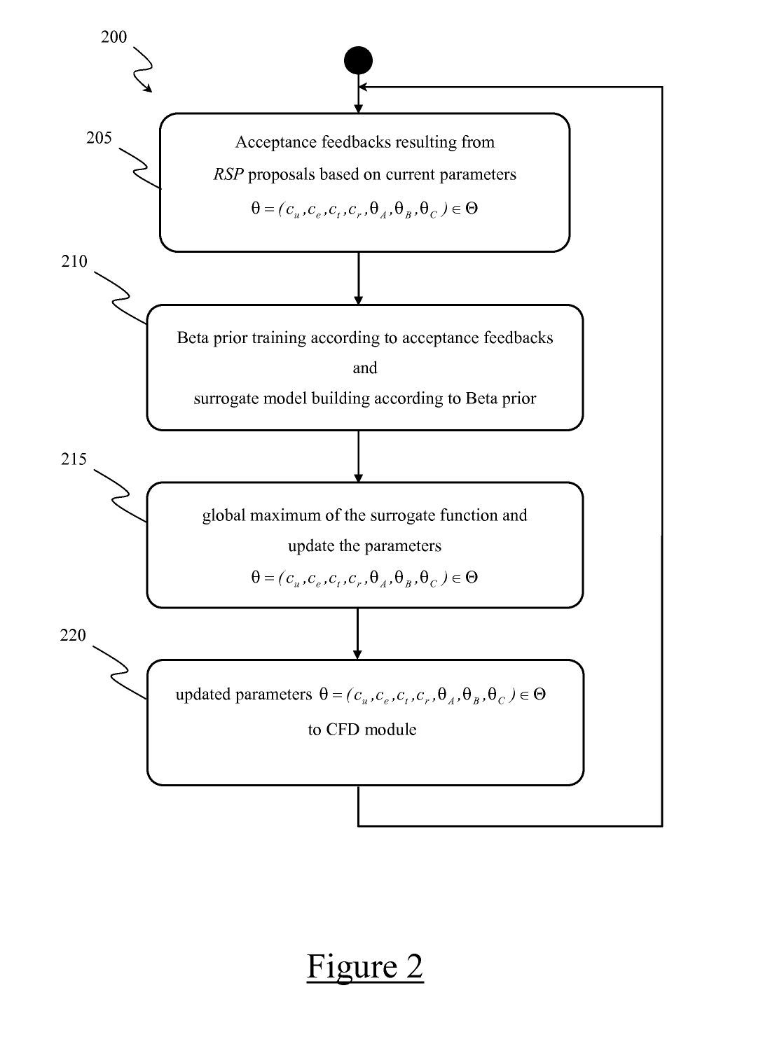

With joint reference to FIG. 2, the main steps of the acceptance rate optimization procedure 200 (performed at the learning module 120) according to an embodiment of the present invention are illustrated.

Broadly speaking, according to such procedure 200, at each iteration, the surrogate model of the objective function (i.e., the unknown acceptance rate function to be optimized by varying the values of the weighting coefficients cᵤ, cₑ, cₜ, cᵣ and of the discriminating thresholds θ_{A}, θ_{B}, θ_{C}) is built (based on training data) and optimized, thereafter an optimum value of the objective function is evaluated and used to update the surrogate model for the next iteration.

More specifically, the procedure 200 iteratively operates as follows.

First (step 205), after (preferably, a predefined number of) RSP proposals are proposed to the RSS users (initial proposals) based on a current knowledge of the weighting coefficients cᵤ, cₑ, cₜ, cᵣ and discriminating threshold θ_{A}, θ_{B}, θ_{C} values, hereinafter globally referred to as policy parameters θ=(cᵤ,cₑ,cₜ,cᵣ,θ_{A},θ_{B},θ_{C})εΘ for the sake of conciseness, being Θ the policy parameter space, the acceptance feedbacks of the ride sharing proposals RSP resulting from optimization of the respective cost function C (i.e., the cost function C built according to the above policy parameters θ=(cᵤ,cₑ,cₜ,cᵣ,θ_{A},θ_{B},θ_{C})εΘ) are received at the learning module 120.

The initial proposals, used as training data to build the surrogate model for the first time, are computed by using random policy parameters θ in the policy parameter space Θ. For example, an approximate prior may be built over the policy parameters θ by experience guessing what values might be most reasonable and their corresponding “spread”, and this information may be used to build a Gaussian sample around the “reasonable” values. Then (step 210), based on the acceptance feedbacks, data is gathered and used to train a Bayesian Beta prior with a basis function kernel—preferably, as better discussed below, a radial basis function Kernel, and more preferably a radial basis function Kernel based on Mahalanobis distance (M. Fauvel, A. Villa, J. Chanussot, and J. A. Benediktsson, “Parsimonious Mahalanobis Kernel for the Classification of High Dimensional Data”). The expected mean and variance of the Beta posterior are determined, and used to build the surrogate model with the “Expected Improvement” criterion (Eric Brochu, Vlad M. Cora and Nando de Freitas, “A Tutorial on Bayesian Optimization of Expensive Cost Functions, with Application to Active User Modeling and Hierarchical Reinforcement Learning”).

The surrogate model is a function ƒ:Θ⊂ [symbol] ⁷→(0,1)⊂ [symbol] that maps each policy parameter θ in the policy parameters space Θ to a value p in [symbol] representing the acceptance probability with those parameters.

If a value of 1 considered where ƒ(θ)>0.5 and a value 0 where ƒ(θ)<0.5, the model becomes a binary classifier. For a binary classifier, when the real stochastic process is a Bernoulli process, such as in the case herein considered of acceptance feedbacks, a candidate prior may be the Beta distribution under Bayesian inference (Montesano, L., & Lopes, M. 2009, “Learning grasping affordances from local visual descriptors”, Proceedings of the 8th IEEE international conference on development and learning, Shanghai, China). The Beta distribution can model a Bernoulli process where α is the number of successes and β is the number of failures. If the prior on the policy parameters θ follows a Beta distribution with prior parameters α and β and the Bernoulli process results in r successes out of m trials, which implies a binomial likelihood function, the posterior distribution over θ also follows a beta distribution (or, otherwise stated, the Beta distribution is a conjugate prior):

θ|r≈Beta(α+r,β+m−r)

Preferably, in order to avoid imbalanced data issues (i.e., inaccurate classifications typically arising in many binary classifiers when two classes do not contain the same number of data points), weighting parameters m₋/m and m₊/m may be used, wherein m₋ and m₊ are the number of negative and positive labels, respectively, in the training set m, so that the Bayesian formulation becomes:

$${θ}_{i} \vert y \approx Beta ( α + \frac{{m}_{-}}{m} \cdot {\sum }_{j} {1}_{{y}_{i} = 1} ( k ( {x}_{i} , {x}_{j} ) ) , β + \frac{{m}_{+}}{m} \cdot {\sum }_{j} {1}_{{y}_{i} = 0} ( k ( {x}_{i} , {x}_{j} ) ) )$$

wherein I_{A}(x) is the general indicator function defined as:

$${1}_{A} ( x ) = \{ \begin{matrix}1 & if x ∈ A \\ 0 & if x ∉ A\end{matrix}$$

The weighting parameters m₋/m and m₊/m balance the likelihood function so that the posterior probability moves to whichever class is closest to xᵢ in the feature space. The expected value of the posterior distribution E[θᵢ]=αᵢ/(αᵢ+βᵢ) can be used for making) predictions. Given a uniform prior wherein α=1 and β=1, an unknown point yᵢ should be positively classified if E[θᵢ]>½ and negatively classified if E[θᵢ]<½.

In the Bayesian model, the posterior variance can express uncertainty in the classifier. For the Beta distribution the variance is given by:

Var(θᵢ)=αᵢβᵢ/└(αᵢ+βᵢ)²(αᵢ+βᵢ+1)┘

The variance can be used in the “Expected Improvement” approach to determine the best query point.

The choice of the kernel function is an important ingredient in a Bayesian predictor, as it encodes the assumptions about the objective function to be “learned”. Among them, “similarity” between data points is herein exemplary considered, which is a basic assumption that points with inputs x close to each other are likely to have similar target values y, and thus training points that are near to a test point should be informative about the prediction at that point. Under the Bayesian kernel view it is the kernel function that defines “nearness” or similarity. Kernel functions that depend only on the distance |x−x′| are stationary and isotropic, and are called “Radial Basis Functions” (RBF). A generalization of the well-known Euclidean distance is the Mahalanobis distance d_{M} between two samples with covariance matrix C_{OV} (the covariance matrix C_{OV} is defined in the input space for all available samples):

d_{M}(x,x′)=\sqrt{(x−x′)^{T}C_{OV}⁻¹(x−x′)}

Computing the covariance matrix C_{OV} for the Mahalanobis distance is equivalent to projecting the data on all the principal components, scale the variance to one, and then applying the Euclidean distance—this is especially important because no worry about the scales of input variables is required. Based on the definition of the Mahalanobis distance, the Mahalanobis kernel may be defined as:

k_{M}(xᵢ,xⱼ)=exp(−(xᵢ−xⱼ)^{T}C_{OV}⁻¹(xᵢ−xⱼ))

Thanks to Mahalanobis kernel, parameters tuning is implicitly taken into account by the covariance matrix C_{OV} in the Mahalanobis distance.

The expected mean and variance of the full Bayesian approach in the case of the Beta distribution allow the application of the “Expected Improvement” method that enables automatic balance in the exploitation/exploration tradeoff. This method takes into account not only the probability of improvement (expected mean), but the magnitude of the improvement a point can potentially yield (variance). Specifically the new query point is found by maximizing the expected improvement (J. Ma\check{c}kus, “Application of Bayesian approach to numerical methods of global and stochastic optimization”):

$$x = arg {max}_{x} E [ max ( 0 , {f}_{t + 1} ( x ) - f ( {x}_{best} ) \vert {D}_{t} ]$$

where x_{best} is the best value so far based on the current data Dₜ (the search process of this optimal point being discussed herebelow).

Then (step 215), having a surrogate function, a global optimization algorithm is applied to find the global maximum, which corresponds to the best parameter values in the policy (D. R. Jones, M. Schonlau, and W. J. Welch, “Efficient global optimization of expensive black-box functions”). Any global optimization algorithm can be used provided it can escape local optima being the surrogate a multi-modal function. In the considered example, the QPSOL algorithm (already used for finding the best matching between RSS users) is used to optimize the surrogate model at the meta-level.

The surrogate function defined above ƒ:Θ⊂ [symbol] ⁷→(0,1)⊂ [symbol] maps each policy parameter θ in the policy parameters space Θ to a value p in [symbol] representing the acceptance probability with the policy parameters θ. Optimizing this surrogate function allows finding the most suitable parameters to use in the cost function C to be solved. The output of the optimization phase will be the policy parameters θ=(cᵤ,cₑ,cₜ,cᵣ,θ_{A},θ_{B},θ_{C})εΘ to be set in the cost function C that are the most promising values on the objective function.

Finally (step 220), the components of the global policy parameters θ determined by optimizing over the surrogate model, are used as policy parameters θ of the RSS system 100 until the next acceptance feedback is received.

Specifically, once the optimum has been found in the surrogate model, the policy policy parameters θ are used in the objective function that is optimized in the passengers/drivers matching algorithm. The “real” acceptance feedback of the new ride sharing proposals RSP is used to update knowledge on the prior by adding the new parameter values, plus the binary score, to the data set of the Beta prior.

In order to avoid overfitting the model, a sliding window of data is maintained that keeps only the most recent observations. Other techniques can be used to achieve the same result, e.g. by weighting the observations with a geometrical decay on their age.

By discarding old data, users preferences are constantly taken into account even if they change over time.

As visible in the figure, no termination criterion has been made explicit. Indeed, in order to take into account RSS user preferences varying over time, the learning procedure 200 is advantageously kept always running.

Back to FIG. 1, the RSS system 100 also comprises a solver module 125 adapted to receive the cost function C to be minimized/optimized, as well as users requests and availability and outputs the “best” matching between drivers and passengers according to minimization performed and on RSS users availability and requests (as indicated in the figure by “Options” input to the solver module 125).

The problem of the minimization of the cost function C described above can be solved adopting many different approaches, not limiting for the present invention. From now on, two main approaches will be considered by way of example only, namely metaheuristic and binary linear programming (exact) approaches.

The metaheuristic approach is based on “Quantum Particle Optimization with Lévy flights” (QPSOL), which is an iterative population-based method in which a swarm S of theoretical particles (usually 20-30 particles) explores the solution space in search for the optimal solution. The position of a particle represents a candidate solution, whose goodness is measured in terms of the cost function. At each iteration the particles move according to a stochastic law that considers:

x(t): the old position of the particle;

g(t): the best position found by the system (considering all particles) until now;

$${x}_{m} ( t ) = \frac{1}{\vert S \vert} {\sum }_{i} {x}_{i} ( t ) \text{:}$$

the center of the swarm, computed as the average of all positions of the particles.

An attractor a(t) is computed for each particle as a(t)=rx(t)+(1−r)g(t), where r is extracted from a uniform random variable between 0 and 1. The new position of each particle is then computed as:

x(t+1)=a(t)+(a(t)−xₘ(t)βλ

where β is a constant and λ is an extraction from a Lévy distribution. This law is applied separately for each component.

QPSOL was developed to deal with continuous problems, where the solution space could be directly represented as a subset of [symbol] ⁿ. Differently, the problem to be solved here is combinatorial, so there is the need for a discretization function in order to convert position in [symbol] ⁿ into solutions in {0,1}^{D×P} and evaluate the cost function C.

In order to work with the highest amount of information possible, the domain of the positions of the particles is actually {0,1}^{D×P}. According to an embodiment, the discretization (also referred to as “defuzzification”) function operates as follows:

a) the highest value max_{i,j}X_{i,j} in the matrix is selected;

b) the correspondent RSS user pair (i,j) is chosen as a member of the matching;

c) the row of the chosen driver and the column of the chosen passenger are set to 0;

d) step a) to c) are repeated until either all rows or all columns are 0;

e) for each pair in the matching, the shortest path that comprehends all waypoints is computed.

The pairs inserted in the matching are then filtered using the predefined thresholds and eventually the cost function can be computed on the resulting data.

With experiments it is possible to observe that the particles explore the solution space with enough variety and sometimes concentrate around good solutions in order to refine them. This results in a progressive improvement of the best solution found.

According to the exact approach, the solution of a problem is expressed in terms of a matrix Xε{0,1}^{\tilde{D}×\tilde{P}}, wherein

X_{i,j} is 1 if the i-th driver and the j-th passenger are associated, 0 otherwise;

\tilde{D}=D∪{N_{D}} and \tilde{P}=P∪{N_{P}}, N_{D} and N_{P} being dummy nodes used to represent the empty assignment (namely, if a RSS user is matched with N_{D} or N_{P}, it means that he/she is not included in the matching).

The exact approach is divided in two sequential phases, namely precomputation of costs, and solution of a binary linear problem with linear constraints.

In the first phase, a certain cost C_{i,j} is associated with each i-th driver/j-th passenger pair, each cost C_{i,j} being modeled after the cost function C and comprising:

l_{i,new}-l_{i,old}, i.e. the extra road to be traveled by the i-th driver, wherein the length of the paths considered is computed as the length of the shortest paths;

wⱼ, i.e. the estimated waiting time of the j-th passenger;

−(R_{i,j}^{D}+R_{j,i}^{P}), i.e. the reciprocal reputation of the two RSS users.

These terms are multiplied by the weighting coefficients cₑ, cₜ, cᵣ, respectively, and then added. For those pairs for which l_{i,new}-l_{i,old} is over the predefined thresholds, the corresponding cost is set to infinity, so that the solver module 125 cannot use them.

Moreover, a set of costs C_{N}_{_{D}}_{,j} for passengers are calculated, which determine the penalty assigned if some passengers are not served. For each j-th this value is computed as the sum of Sⱼ^{P} and a value representing the time passed since when the RSS system 100 has received the request by that RSS user. This is useful to give more priority to RSS users who have a high global reputation value and to those who have been waiting longer. The final result is then multiplied by the coefficient cᵤ.

The second phase consists in solving the following linear problem:

$${min}_{X} {\sum }_{{i ∈ \tilde{D}}_{j ∈ \tilde{P}}} {C}_{i , j} {X}_{i , j}$$

subject to:

$$\{ \begin{matrix}X ∈ {\{ 0 , 1 \}}^{\tilde{D} \times \tilde{P}} \\ {\sum }_{i ∈ D} {X}_{i , j} = 1 , ∀ j ∈ P \\ {\sum }_{j ∈ P} {X}_{i , j} = 1 , ∀ i ∈ D\end{matrix}$$

This formulation of the cost function C is equivalent to the one presented above, so the solution of both minimization problems is the same. The actual computation of the solution is easily delegated to a specialized “Mixed integer linear programming MILP” solver.

As should be readily understood, the approach deemed more suitable can be used, according to specific design option and to specific requirements in terms of performance to be achieved. For example, the choice may be based by considering that the exact approach guarantees optimal solutions but execution time strongly depends on the number of RSS users (and is very susceptible to changes in the structure of the service in terms of execution times), and that the metaheuristic approach, on the contrary, does not guarantee optimal solutions but a valid (although non-optimal) solution is available at any time and its quality improves as time goes on, and the performance thereof is way less dependent on the structure of the problem.

It is pointed out that, whichever approach is used, the computation of the distances between two points must take into account the complexity of the urban environment. In fact, various factors can influence the time needed to move from a location to another one (such as one-way streets, bridges, traffic and so on). This problem can be addressed by pre-computing some of the distances using a custom metric that takes into account these factors and then use a fast method for shortest path computing like contraction hierarchies to reduce the memory and time requirements of such approach. Preferably, the pre-computed distances are updated at fixed intervals of time by a separate process, in order to keep them as adherent as possible to reality.

Naturally, in order to satisfy local and specific requirements, a person skilled in the art may apply to the solution described above many logical and/or physical modifications and alterations. More specifically, although the present invention has been described with a certain degree of particularity with reference to preferred embodiments thereof, it should be understood that various omissions, substitutions and changes in the form and details as well as other embodiments are possible. In particular, different embodiments of the invention may even be practiced without the specific details set forth in the preceding description for providing a more thorough understanding thereof; on the contrary, well-known features may have been omitted or simplified in order not to encumber the description with unnecessary details. Moreover, it is expressly intended that specific elements and/or method steps described in connection with any disclosed embodiment of the invention may be incorporated in any other embodiment as a matter of general design choice.

More specifically, the solution according to an embodiment of the invention lends itself to be implemented through an equivalent method (by using similar steps, removing some steps being not essential, or adding further optional steps); moreover, the steps may be performed in different order, concurrently or in an interleaved way (at least partly).

In addition, analogous considerations apply if the RSS system has a different structure or comprises equivalent components, or it has other operating features. In any case, any component thereof may be separated into several elements, or two or more components may be combined into a single element; in addition, each component may be replicated for supporting the execution of the corresponding operations in parallel. It should also be noted that any interaction between different components generally does not need to be continuous (unless otherwise indicated), and it may be both direct and indirect through one or more intermediaries.

For example, the RSS system may be configured to deal with free pickup and dropoff points (i.e., ride sharing takes place wherever the j-th passenger(s) ask for a lift), with predetermined meeting points (e.g., predefined areas of the city devoted to passengers pickup and dropoff), or with a combination thereof, without that the principles of the present invention are affected.

1. A method for arranging, in a ride sharing system providing a ride sharing service, ride sharing proposals to users of the ride sharing service, the method comprising:
determining candidate users groups each one comprising users potentially matching to share a ride;
defining a cost function comprising, for each candidate users group, at least one term indicative of an impact on the users of the ride sharing service in case the ride sharing takes place among candidate users group, and at least one weighting coefficient (cu, ce, ct, cr) each one associated with a respective one of said at least one term;
minimizing the cost function thereby obtaining ride sharing proposals for the users;
sending the ride sharing proposals to the respective users;
receiving by the users acceptance feedbacks indicative of acceptance or rejection of the ride sharing proposals; and
dynamically varying a value of said at least one weighting coefficient according to an acceptance rate of the ride sharing proposals by the users.

2. The method according to claim 1, wherein the users of the ride sharing service comprise drivers and passengers, and wherein said at least one term of the cost function comprises, for each candidate users group, at least one between:
a term indicative of a number of passengers not assigned to any driver;
a term indicative of an estimated extra road for the driver;
a term indicative of waiting times of the passengers; and
a term indicative of reputation scores of the driver and of the passenger.

3. The method according to claim 2, wherein said number of passengers not assigned to any driver are discriminated according to at least one threshold comprising at least one between an extra road threshold indicative of a maximum allowed extra road that satisfying the passengers would imply for the drivers, and a waiting time threshold indicative of a maximum allowed waiting time that satisfying the passengers would imply for drivers and/or passengers, and wherein said dynamically varying a value of said at least one weighting coefficient according to an acceptance rate of the ride sharing proposals (RSP) by the users further comprises dynamically varying also a value of said at least one threshold according to the acceptance rate of the ride sharing proposals by the users.

4. The method according to claim 1, wherein said dynamically varying comprises performing a learning procedure based on history values of said at least one weighting coefficient and on the acceptance rate of the ride sharing proposals resulting from the minimization of the respective cost functions.

5. The method according to claim 4, wherein said performing a learning procedure comprises, at each iteration:
receiving the acceptance feedbacks of the ride sharing proposals resulting from the minimization of the cost function based on the values of at least one weighting coefficient determined at a previous iteration;
based on the acceptance feedbacks, training a Bayesian Beta prior with a basis function kernel, and building a surrogate model of the acceptance rate according to mean and variance of the Bayesian Beta prior; and
finding a global maximum of the surrogate model, said global maximum corresponding to values of the at least one weighting coefficient that maximize the acceptance rate at the current iteration.

6. The method according to claim 5, wherein:
said performing a learning procedure is also based on history values of said at least one threshold;
at each iteration, said receiving comprises receiving the acceptance feedbacks of the ride sharing proposals resulting from the minimization of the cost function further based on the values of the at least one threshold determined at the previous iteration, and wherein
said global maximum further corresponding to values of the at least one threshold that maximize the acceptance rate at the current iteration.

7. The method according to claim 5, wherein said building a surrogate model comprises building a surrogate model by means of an “Expected Improvement” criterion.

8. The method according to claim 5, wherein said finding a global maximum of the surrogate model is based on “Quantum Particle Optimization with Lévy flights” approach.

9. The method according to claim 5, wherein said receiving the acceptance feedbacks comprises receiving a predefined number of acceptance feedbacks about the ride sharing proposals before starting said training a Bayesian Beta prior with basis function kernel, said building a surrogate model and said finding a global maximum of the surrogate model.

10. The method according to claim 4, further comprising keeping the learning procedure always running while the method is performed.

11. The method according to claim 2, wherein said reputation scores comprise, for each candidate user group, a first reputation score of the driver according to the passenger, and a second reputation score of the passenger according to the driver, the method further comprising:
updating the first reputation score at the reception of each first reputation feedback about the driver from the passenger; and
updating the second reputation score at the reception of each second reputation feedback about the passenger from the driver.

12. The method according to claim 11, wherein said updating the first reputation score, respectively the second reputation score, is based on a parameter depending on a number of received first reputation feedbacks, respectively second reputation feedbacks, and on a time passed since the last first reputation feedbacks, respectively the last second reputation feedback, received.

13. The method according to claim 11, further comprising:
determining a first further reputation score of the driver according to the ride sharing system and a second further reputation score of the passenger according to the ride sharing system; and
calculating first, respectively second, global reputation scores according to the first and first further reputation scores, respectively according to the second and second further reputation scores, the term of the cost function indicative of the number of passengers not assigned to any driver and the term of the cost function indicative of waiting times of the passengers depending on said second global reputation score.

14. The method according to claim 1, wherein said minimizing the cost function is performed by means of a metaheuristic approach based on “Quantum Particle Optimization with Lévy flights”, or by means of an exact approach.

15. A computer program product directly loadable into a memory of a computer, the computer program product comprising software code means adapted to perform the method of claim 1.

16. A ride sharing system providing a ride sharing service, the ride sharing system comprising:
a first module for providing, to users of the ride sharing service, ride sharing proposals and for receiving by the users acceptance feedbacks indicative of acceptance or rejection of the ride sharing proposals,
a second module for defining a cost function comprising, for each candidate users group each one comprising users potentially matching to share a ride, at least one term indicative of an impact on the users of the ride sharing service in case the ride sharing takes place among the candidate users group, and at least one weighting coefficient each one associated with a respective one of said at least one term;
a third module for dynamically varying a value of said at least one weighting coefficient according to an acceptance rate of the ride sharing proposals by the users, and
a fourth module for minimizing the cost function thereby obtaining the ride sharing proposals for the users.
